(19) United States
(12) Patent Application Publication
(10) Pub. No.: US 2008/0202408 A1
(43) Pub. Date: Aug. 28, 2008

(54) ILLUMINATED INSTRUMENT CLUSTER

(75) Inventor: Kenichi Takato, Rochester Hills, MI (US)

Correspondence Address: SIEMENS CORPORATION;INTELLECTUAL PROPERTY DEPARTMENT, 170 WOOD AVENUE SOUTH, attn: VDO - CGO docketing migration, ISELIN, NJ, 08830, US

(73) Assignee: CONTINENTAL AUTOMOTIVE SYSTEMS US, INC., Auburn Hills, MI (US)

(21) Appl. No.: 12/035,533

(22) Filed: Feb. 22, 2008

Related U.S. Application Data
(60) Provisional application No. 60/903,267, filed on Feb. 23, 2007.

(51) Int. Cl. G01D 13/28

(52) U.S. Cl. 116/288

(57) ABSTRACT

An illuminated instrument assembly includes a light housing that defines an interior space over which is supported a dial face. A pointer rotates below the dial face and is visible through a clear portion of the dial face. The light housing is fabricated from a white material and provides the background visible that provides the desired contrast between the dial face and the pointer. Light from a light guide integral with the pointer is directed through the pointer and into the interior space behind the dial face.

### CROSS REFERENCE TO RELATED APPLICATION

The application claims priority to U.S. Provisional Application No. 60/903,267 which was filed on Feb. 23, 2007.

### BACKGROUND OF THE INVENTION

This invention generally relates to an illuminated instrument cluster. More particularly, this invention relates to an instrument cluster including a pointer and dial face both illuminated by a common light source.

Conventional instrument dials and gauges include a pointer that rotates above or in front of a dial face. The dial face includes a scale over which the pointer moves to communicate a measured vehicle parameter such as speed. The pointer is sometimes illuminated with a light source that projects light upward into the pointer. The dial face and scale can be similarly illuminated with lights disposed behind the dial face where lighting is desired. Disadvantageously, each light source is typically supported on a printed circuit board. Therefore every location where a light is desired requires backing by the circuit board. This can result in the need for one large circuit board. As appreciated, such configurations are not efficient and contribute to the overall cost of the instrument dial or gauge.

### SUMMARY OF THE INVENTION

A disclosed example illuminated instrument assembly includes a light housing that defines an interior space over which is supported a dial face. The dial face includes a scale such as a speedometer. A pointer rotates below the dial face and about an axis relative to the scale. The pointer is visible through a clear portion of the dial face and the light housing is fabricated from a white material and provides the background visible to an operator. The light housing of white material provides the desired contrast between the dial face and the pointer.

The pointer includes a central light guide from which a pointer arm radially extends. Light from the light guide is directed through the pointer arm and into the interior space behind the dial face. Light is therefore utilized to both light the pointer arm and backlight the scale.

These and other features of the present invention can be best understood from the following specification and drawings, the following of which is a brief description.

### BRIEF DESCRIPTION OF THE DRAWINGS

FIG. 1 is a sectioned perspective view of an example instrument cluster assembly.

FIG. 2 is a cross-sectional view of an example printed dial face

FIG. 3 is an exploded view of the example instrument cluster assembly.

FIG. 4 is a cross-sectional view of the example instrument cluster assembly.

FIG. 5 is a perspective view of an example pointer.

### DETAILED DESCRIPTION OF THE PREFERRED EMBODIMENT

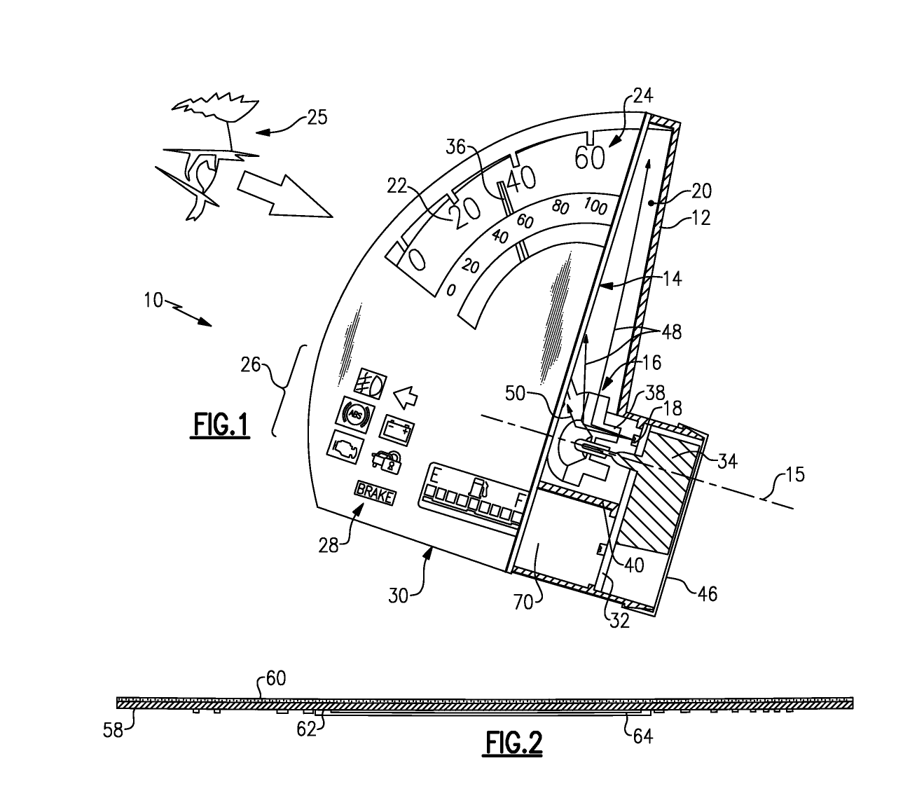

Referring to FIG. 1, an illuminated instrument assembly 10 includes a light housing 12 that defines an interior space 20 over which is supported a dial face 14. The dial face 14 includes a scale 24 indicative of a measured vehicle operating parameter, such as for example vehicle speed as is illustrated in FIG. 1. A pointer 16 rotates below the dial face 14 and about an axis 15 relative to the scale 24 to indicate a current measured value. The pointer 16 includes a pointer arm 36 that is visible through a clear portion 22 of the dial face 14. The light housing 12 is fabricated from a white material and provides the background visible to an operator 25 through the clear portion 22 of the dial face 14. Because the light housing 12 is fabricated from a white material, no additional coating or process is required to provide the desired contrast between the dial face 14 and the pointer arm 36.

The dial face 14 also includes a first group of symbols 26 that are selectively illuminated to communicate a desired vehicle condition or operational parameter. Additionally, the dial face 14 includes a second symbol 28, in this example the work “BRAKE”, and a third symbol 30, in this example the fuel gauge that are also selectively illuminable.

Referring to FIG. 2, with continued reference to FIG. 1, each of the symbols 26, 28, 30 and the scale 24 are generated by printing supported on a clear substrate 58. Black ink or other known material is printed over the clear substrate 58 to create the desired shape and numerical references for the scale 60. A white pad printing 62 is locally applied to improve and accentuate illumination is specific desired portions of the dial face 14. Additionally, a black pad printing 64 is applied to the areas that are not desired to transmit light. The clear portions 22 provide for the viewing through the dial face 14 of the pointer arm 36 that provides the reference on the scale 24. The example clear portion 22 surrounds the numerals of the scale 24.

The pointer 16 is disposed within a first interior space 20 behind the dial face 14 and is driven by a movement 34 supported on a printed circuit board (PCB) 32. A back cover 46 is disposed over a backside of the light housing 12 enclosing the movement 34.

The first interior space 20 is provided with light sources 18. The first interior space 20 is separated from a second interior space 70 by a light-blocking wall 40. The second interior space includes additional light sources for selectively illuminating the secondary symbols 26, 28 and 30. The example light sources are light emitting diodes; however other known light sources are within the contemplation of this invention.

The example pointer 16 includes a central light guide 38 from which the pointer arm 36 radially extends. A first portion of light 50 from the light guide 38 is directed through the pointer arm 36 and a second portion 48 is directed into the interior space 20 behind the dial face 14 and the clear portion 22.

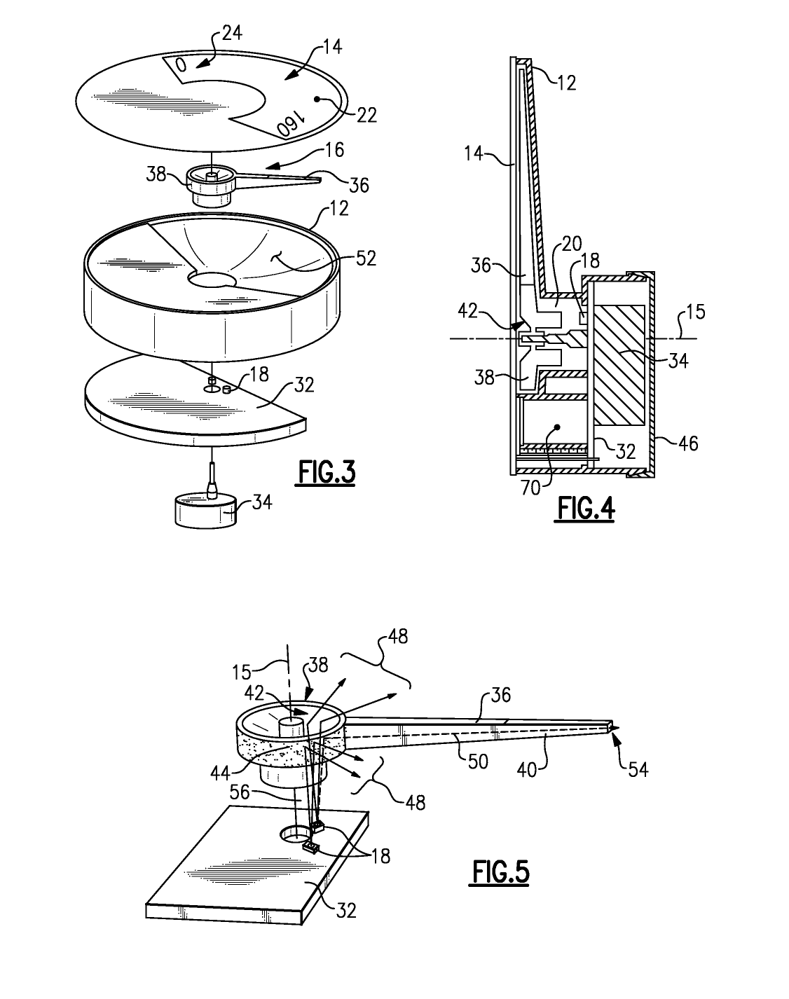

Referring to FIGS. 3 and 4, the light housing includes the white surface 52 that provides the background for the scale 24 printed in the clear portion 22. The white surface 52 is provided by utilizing a white plastic material to fabricate the light housing 12. The white surface 52 contrasts with the black scale 24 and the pointer 16 disposed below the dial face 13. The PCB 32 supports the LEDs 18 that illuminates the pointer 16 and back lights the dial face 14. The movement 34 is in turn supported behind the PCB 32 and includes a shaft that rotates the pointer 16 about the axis 15.

The pointer 16 includes the central light guide 38 that includes the reflective surface 42. The pointer arm 36 extends radially from the central light guide 38. Light from the LED 18 is directed through the central light guide 38 off the reflective surface 42 and through to the pointer arm 36. Light is also transmitted through the light guide 38 and outwardly behind the dial face 14.

Referring to FIG. 5, the pointer 16 includes the central light guide 38 that is circular and centered on the axis 15. The central light guide 38 includes the reflective surface 42. The reflective surface 42 is concave and circumferential about the axis 15. The reflective surface 42 is angled relative to the axis 15 to direct light transverse to the axis 15 and to the direction of incoming light indicated by arrows 56. An outer periphery of the central light guide 38 includes he light transmitting surface 44. Light from the light source is directed by the light-reflecting surface and out the light transmitting surface 44.

The light 56 from the LEDs 18 is therefore utilized to both light the pointer arm 36 but also to illuminate and backlight the scale 24 on the dial face 14. Rotation of the pointer 36 does not distort or change the amount of light for the backlighting of the dial face 14 because light is transmitted radially outward both through the light transmitting surface 44 and through the pointer arm 36.

Light 56 originating from the LEDs 18 is transmitted upwardly parallel with the axis 15 into the central light guide 38. The central light guide 38 is circular and rotates about the axis 15 with the pointer 16. Light is then reflected by the light-reflecting surface 42 transverse to the axis 15. A portion of light 48 is emitted from the light-transmitting surface 48 and into the space 20 behind the dial face. Another portion of light 50 is transmitted into the pointer arm 36. The light 50 illuminates the pointer arm 36 and then is emitted as indicated at 54 from the pointer tip out into the space 20. The light utilized to backlight the dial is thereby also utilized to illuminate the pointer 16. Further, the use of one light source for both illuminating the dial face 14 and the pointer 16 provides for a reduced size PCB 32 because the light sources can be located near to the axis of rotation and are not required to be located through out the entire interior space 20 of the light housing 12.

During operation where the instrument is not lighted, the white background provided by the white light housing 12 provides a clear contrast with the scale 24 and the pointer 16. The contrast makes viewing easy for the operator 25.

Accordingly, the example instrument assembly 10 provides both illuminated and non-illuminated viewing with a clear dial and the white background provided by the white light housing 12.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. An illuminated gauge assembly comprising:
a light housing defining an interior space;
a dial face mounted over the light housing;
a pointer disposed within the interior space between the dial face and the light housing and visible through portions of the dial face; and
a light source illuminating both the pointer and the dial face.

2. The assembly as recited in claim 1, wherein the dial face includes a clear portion on which are disposed indicators of a measured operational parameter.

3. The assembly as recited in claim 2, wherein the light housing comprises a white material visible through the clear portion of the dial face.

4. The assembly as recited in claim 1, wherein the pointer comprises a central light guide and a pointer arm extending radially outward from the central light guide.

5. The assembly as recited in claim 4, wherein the central light guide includes a reflective surface directing light from the single light source into the pointer arm and out into the interior space.

6. The assembly as recited in claim 5, wherein the central light guide includes a light transmitting surface disposed transverse to the light source for directing light into the interior space.

7. The assembly as recited in claim 6, wherein the light-transmitting surface includes a texture.

8. The assembly as recited in claim 1, including a printed circuit board on which the light source is mounted.

9. The assembly as recited in claim 1, wherein the dial face comprises a clear substrate on which is printed a scale representing a measured parameter, and the pointer visible through the clear substrate proximate the scale to indicate a value of the measured parameter.

10. The assembly as recited in claim 9, wherein the dial face includes printed symbols for communicating information secondary to the measured parameter.

11. An illuminated dial assembly comprising:
a light housing comprising a white interior surface;
a dial face disposed over the light housing, the dial face including a scale having clear portions;
a pointer disposed between the dial face and the light housing, the pointer visible through the clear portions of the scale; and
a light source supported within the light housing for illuminating both the pointer and the dial face.

12. The assembly as recited in claim 1, wherein the pointer comprises a light guide and a pointer arm extending radially from the light guide, the light guide receiving light from the light source and directing light into both the pointer arm and into a space within the light housing below the dial face.

13. The assembly as recited in claim 12, wherein the light guide includes a reflecting surface and a light-transmitting surface, the light transmitting surface directing light transverse to an axis of rotation of the pointer.

14. The assembly as recited in claim 13, wherein the reflecting surface is disposed entirely about the axis of rotation.

15. The assembly as recited in claim 11, including a circuit board supporting the light source and a movement for rotating the pointer relative to the scale.

16. The assembly as recited in claim 15, wherein the circuit board includes a first section isolated from a second section, the first section including a first light source for illuminating the pointer and the scale, the second portion including a second light source for illuminating a second portion of the dial face separate from the scale.

17. The assembly as recited in claim 11, wherein the light housing comprises a white material.
